(19) United States
(12) Patent Application Publication
(10) Pub. No.: US 2024/0220761 A1
(43) Pub. Date: Jul. 4, 2024

(54) MEMORY CARD

(71) Applicant: Samsung Electronics Co., Ltd., Suwon-si (KR)

(72) Inventor: Youngwoo Park, Suwon-si (KR)

(21) Appl. No.: 18/517,942

(22) Filed: Nov. 22, 2023

(30) Foreign Application Priority Data
Dec. 30, 2022 (KR) 10-2022-0191079

(51) Int. Cl. G06K 19/077; G06K 19/06

(52) U.S. Cl. CPC G06K 19/07747; G06K 19/06121; G06K 19/07732; G06K 19/07743

(57) ABSTRACT

A memory card includes a case including a first case portion and a second case portion that is coupled to the first case portion, an integrated circuit package located in the case, and a marking layer located in the case, wherein the second case portion includes a through-hole, wherein the marking layer is exposed to an outside through the through-hole.

### CROSS-REFERENCE TO RELATED APPLICATION

This application is based on and claims priority under 35 U.S.C. § 119 to Korean Patent Application No. 10-2022-0191079, filed on Dec. 30, 2022, in the Korean Intellectual Property Office, the disclosure of which is incorporated by reference herein in its entirety.

### BACKGROUND

The inventive concept relates to a memory card, and more particularly, to a memory card in which visibility of product information marking is improved.

Memory cards may be widely used in mobile phones, laptop computers, digital cameras, etc. because they may easily store and carry high-capacity information. Memory cards having a large storage capacity, high reliability, for example, low warpage, and improved productivity are required.

### SUMMARY

The inventive concept provides a memory card in which visibility of product information marking is improved.

The inventive concept provides a memory card with improved productivity.

Technical problems to be solved by the inventive concept are not limited to the above- described technical problems and one of ordinary skill in the art will understand other technical problems from the following description.

According to an aspect of the inventive concept, there is provided a memory card including a case including a first case portion and a second case portion that is coupled to the first case portion, the case further including a recess groove recessed inward on one side, an integrated circuit package located in the case and including a panel substrate and a stacked memory chip, a marking layer located in the case, and an adapter including an insertion hole into which the case is inserted, wherein the case includes a marking area in the second case portion, wherein the second case portion includes a plurality of through-holes in the marking area, wherein the marking layer covers the marking area on a top surface of the second case portion.

According to another aspect of the inventive concept, there is provided a memory card including a case including a first case portion and a second case portion that is coupled to the first case portion, an integrated circuit package located in the case, and a marking layer located in the case, wherein the second case portion includes a through-hole, wherein the marking layer is exposed to an outside through the through-hole.

According to another aspect of the inventive concept, there is provided a memory card including a first case portion, a second case portion coupled to the first case portion and including a marking area, an integrated circuit package located between the first case portion and the second case portion, and a marking layer located between the integrated circuit package and the second case portion, wherein the second case portion includes a plurality of through-holes in the marking area.

### BRIEF DESCRIPTION OF THE DRAWINGS

Embodiments will be more clearly understood from the following detailed description taken in conjunction with the accompanying drawings in which:

FIG. 1 is a plan view schematically illustrating a memory card, according to an embodiment;

FIG. 2 is a bottom view schematically illustrating a memory card, according to an embodiment;

FIG. 3 is an exploded perspective view schematically illustrating a memory card, according to an embodiment;

FIG. 4 is a plan view schematically illustrating an integrated circuit package of the memory card of FIG. 1;

FIG. 5 is a plan view schematically illustrating a memory card, according to an embodiment;

FIG. 6 is a bottom view schematically illustrating a memory card, according to an embodiment;

FIG. 7 is a plan view schematically illustrating an integrated circuit package of the memory card of FIG. 5;

FIG. 8 is a cross-sectional view illustrating the memory card of FIG. 6, taken along line X-X′ in FIG. 6;

FIG. 9 is a bottom view schematically illustrating a memory card, according to an embodiment; and

FIG. 10 is a perspective view schematically illustrating a memory card, according to an embodiment.

### DETAILED DESCRIPTION OF THE EMBODIMENTS

As the inventive concept allows for various changes and numerous embodiments, some embodiments will be illustrated in the drawings and described in the detailed description. However, the present embodiments are not limited to specific described ones.

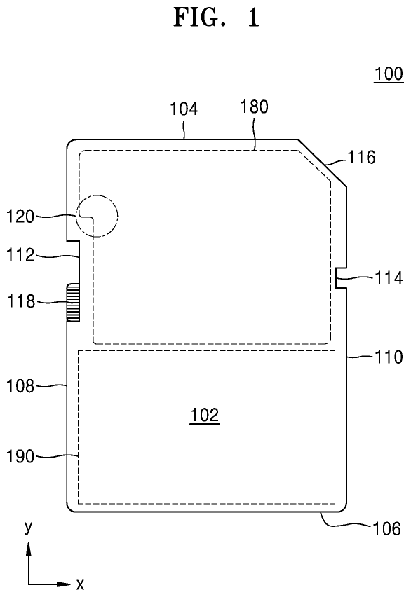

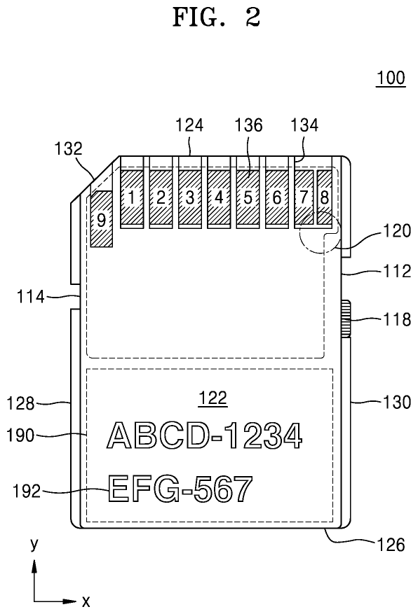

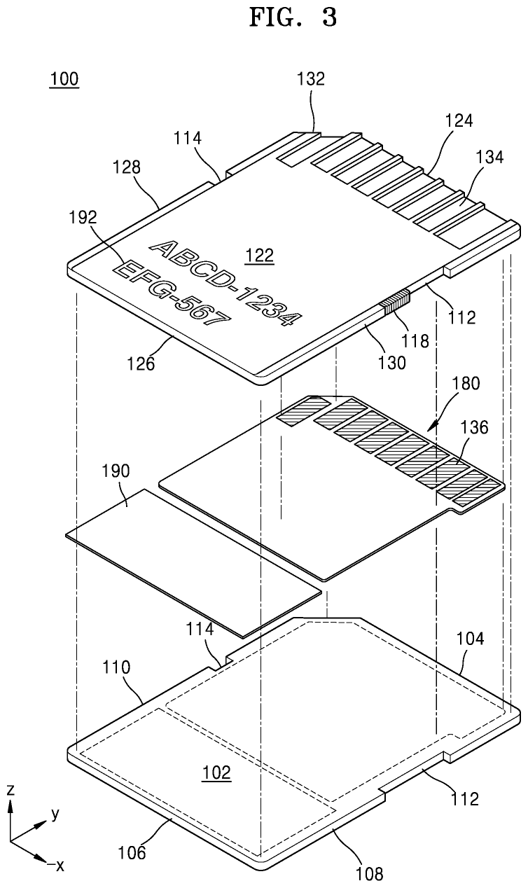

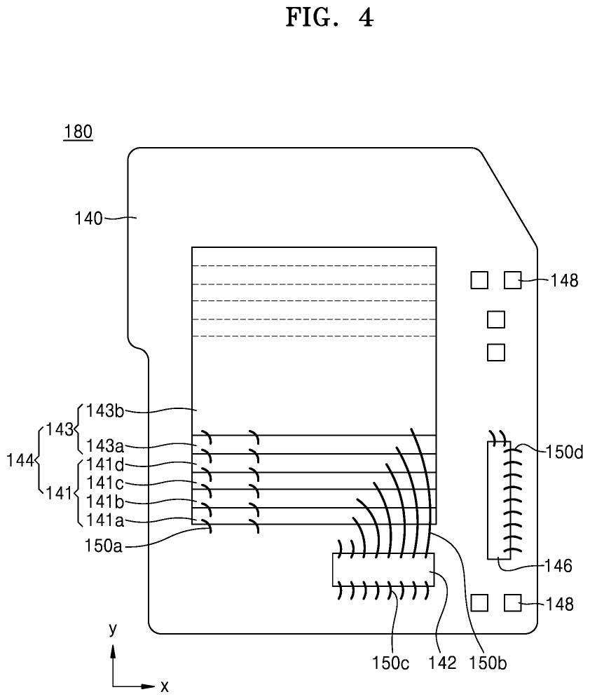

FIG. 1 is a plan view schematically illustrating a memory card, according to an embodiment. FIG. 2 is a bottom view schematically illustrating a memory card, according to an embodiment. FIG. 3 is an exploded perspective view schematically illustrating a memory card, according to an embodiment. FIG. 4 is a plan view schematically illustrating an integrated circuit package of the memory card of FIG. 1.

Referring to FIGS. 1 to 4, a memory card 100 may include first and second case portions 102 and 122, an integrated circuit package 180, and a marking layer 190.

In detail, a Y axis direction may be a direction perpendicular to an X axis direction on a surface of the memory card 100 or the integrated circuit package 180. A Z axis direction may be a direction perpendicular to the X axis direction and the Y axis direction. The X axis direction and the Y axis direction may be respectively a short axis direction and a long axis direction of the memory card 100 or the integrated circuit package 180.

The memory card 100 may be a secure digital (SD) card. The integrated circuit package 180 may be referred to as a semiconductor package. The first case portion 102 and the second case portion 122 may surround the integrated circuit package 180 according to a form or a shape of the integrated circuit package 180. The second case portion 122 may be coupled to the first case portion 102. Specific outer shapes of the first case portion 102 and the second case portion 122 will be described below.

The first case portion 102 and the second case portion 122 may be coupled to each other. In an example, the first case portion 102 and the second case portion 122 may be coupled to each other to form an inner space. The first case portion 102 and the second case portion 122 may be coupled to each other to include the integrated circuit package 180 and the marking layer 190 therein.

The first and second case portions 102 and 122 may be referred to as housings. The first and second case portions 102 and 122 may be referred to as outer lids. When the memory card 100 is an SD card, sizes of the first case portion 102 and the second case portion 122 may be determined according to standard specifications.

The second case portion 122 may include openings 134 through which external contact terminals 136 of the integrated circuit package 180 are exposed. The external contact terminals 136 may include first to ninth external contact terminals 1 to 9.

The external contact terminals 136 may be a signal terminal, a ground terminal, and power supply terminals. The first to eighth external contact terminals 1 to 8 of the external contact terminals 136 may be aligned in a horizontal direction (X axis direction), and the ninth external contact terminal 9 may be located at a lower position than the first to eighth external contact terminals 1 to 8 due to upper and lower case chamfers 116 and 132 in a negative vertical direction (−Y axis direction).

The second case portion 122 may include a plurality of through-holes 192. The second case portion 122 may include a hole passing from a top surface to a bottom surface. The second case portion 122 may include the plurality of through-holes 192 through which the inner space of the first and second case portions 102 and 122 is exposed to the outside.

The plurality of through-holes 192 of the second case portion 122 may be formed to display product information of the memory card 100 in characters. When the memory card 100 is viewed from the bottom surface, the plurality of through-holes 192 may appear as characters conveying the product information. In some embodiments, the plurality of through-holes 192 may be formed by using a laser engraving method. The plurality of through-holes 192 indicating the product information may be formed in a certain portion of the second case portion 122 by using a laser engraving method. The through-holes 192 can form e.g. alphanumeric information, or alternatively (or additionally) form other information in visual and/or topographical format (e.g. logo, product or source information, braille for the sight impaired etc.) or a QR code to provide additional information to the viewer such as via a code reader or scanner. Product information can include brand and model, memory type, storage capacity, UHS speed class, UHS bus class, video speed class, etc. The through-holes 192 may form a topographical area having a topography with higher and lower areas, lower areas corresponding to the marking layer 190 and higher areas corresponding to the external or top surface of the second case portion 122. The through-holes may be filled with a transparent material in some examples, or a material having a reflectivity or color different than the second case portion.

In some embodiments, the second case portion 122 may include a marking area. The marking area may be an area indicating the product information of the memory card 100. The plurality of through-holes 192 may be located in the marking area.

The integrated circuit package 180 of the memory card 100 may be located in the first and second case portions 102 and 122. The integrated circuit package 180 may be located between the first case portion 102 and the second case portion 122. In some embodiments, the first case portion 102 may be located over the integrated circuit package 180, and the second case portion 122 may be located under the integrated circuit package 180.

In some embodiments, the integrated circuit package 180 may be a system-in-package or a multi-chip package. The integrated circuit package 180 may include a stacked memory chip 144, a controller chip 146, and a passive element 148.

In some embodiments, the integrated circuit package 180 may include the stacked memory chip 144, the controller chip 146, the passive element 148, and a molding layer (not shown) located on the panel substrate 140. In some embodiments, the integrated circuit package 180 may further include a frequency boosting interface (FBI) chip 142.

The panel substrate 140 may be an integrated circuit board (PCB), a lead frame, or a tape-type substrate. In the present embodiment, the panel substrate 140 may be a PCB. The PCB may include a dielectric core layer, and a conductive layer located on a top surface and/or a bottom surface of the dielectric core layer.

A conductive pattern (not shown) may be formed on a bottom surface and/or a top surface of the panel substrate 140. The conductive pattern may include a contact terminal, a contact pad, a lead pattern, and a connector. The conductive pattern may be a pattern for electrical connection between electronic elements mounted on the panel substrate 140 and an external electronic device.

The stacked memory chip 144 may be a stack structure in which a plurality of memory chips (e.g., 141 and 143) are stacked stepwise on the panel substrate 140. The memory chips (e.g., 141 and 143) may be adhered to each other by using an adhesive layer.

The plurality of memory chips (e.g., 141 and 143) may be electrically connected to the panel substrate 140 by using a first connection member 150a, for example, a bonding wire. The memory chips (e.g., 141 and 143) may be electrically connected to each other by using the first connection member 150a. The memory chips (e.g., 141 and 143) may be vertical NAND flash memory chips. The vertical NAND chip may have at least 176 layers of NAND flash cells, or even 232 layers or more.

In some embodiments, the stacked memory chip 144 may include a base stacked memory chip 141 and an additional stacked memory chip 143. Although the number of base stacked memory chips 141 (i.e., 141a, 141b, 141c, and 141d) is 4 in FIG. 4, the number of base stacked memory chips 141 is not limited thereto. In addition, although the number of additional stacked memory chips 143 (i.e., 143a and 143b) is 2in FIG. 4, the number of additional stacked memory chips 143 is not limited thereto, and the additional stacked memory chips 143 may not be included.

The integrated circuit package 180 includes the controller chip 146. The controller chip 146 may be located on the panel substrate 140 to be spaced apart from the stacked memory chip 144. The controller chip 146 may be electrically connected to the panel substrate 140 by using a fourth connection member 150d, for example, a bonding wire.

The controller chip 146 may be electrically connected to the stacked memory chip 144. The controller chip 146 may control the stacked memory chip 144. The controller chip 146 may be used to store or read data in the stacked memory chip 144 according to a data storage method.

The integrated circuit package 180 may include the passive element 148 and the molding layer. The passive element 148 may be a capacitor or a resistor. The molding layer may be an epoxy layer. The molding layer may mold the stacked memory chip 144, the controller chip 146, and the passive element 148 located on the panel substrate 140. In some embodiments, the molding layer may contact the first case portion 102, and the panel substrate 140 may contact the second case portion 122.

In some embodiments, the integrated circuit package 180 may further include the FBI chip 142. The FBI chip 142 may be mounted on the panel substrate 140 to be spaced apart from the stacked memory chip 144. The FBI chip 142 may be electrically connected to the stacked memory chip 144 by using a second connection member 150b, for example, a bonding wire. The FBI chip 142 may be electrically connected to the panel substrate 140 by using a third connection member 150c, for example, a bonding wire.

The marking layer 190 of the memory card 100 may be located within the first and second case portions 102 and 122. The marking layer 190 may be located between the first case portion 102 and the second case portion 122. In some embodiments, the first case portion 102 may be located over the marking layer 190, and the second case portion 122 may be located under the marking layer 190.

The marking layer 190 may be exposed to the outside through the plurality of through-holes 192 of the second case portion 122. A color of the marking layer 190 may be different from a color of the first and second case portions 102 and 122. In some embodiments, the first and second case portions 102 and 122 may be green, and the marking layer 190 may have a color other than green. Accordingly, when the marking layer 190 is exposed to the outside through the plurality of through-holes 192 of the second case portion 122, visibility of the marking layer 190 may be improved due to a color different from that of the second case portion 122.

The marking layer 190 may be identified by a user by being exposed to the outside through the plurality of holes 192 of the second case portion 122. The marking layer 190 located in the inner space of the first and second case portions 102 and 122 may be exposed to the outside through the plurality of through-holes 192. In this case, because a color of the first and/or second case portions 102 and 122 and a color of the marking layer 190 are different from each other, the product information of the memory card 100 displayed through the plurality of through-holes 192 may be identified by the user.

Because the marking layer 190 (e.g., a buffer layer) having a color different from that of the first and/or second case portions 102 and 122 is located inside the case and is exposed to the outside through the plurality of through-holes 192, a color different from that of the first and/or second case portions 102 and 122 may be identified through the plurality of through-holes 192.

For example, the product information may be displayed, by engraving the plurality of through-holes 192 in the second case portion 122 that is a lower case among the first and second case portions 102 and 122. In this case, because the marking layer 190 having a color different from that of the second case portion 122 is exposed to the outside through the plurality of through-holes 192, visibility of an engraved portion may be improved. In some embodiments, characters may be engraved in the second case portion 122, and a portion of the marking layer 190 uncovered by the engraved characters may be exposed to the outside.

In some embodiments, the marking layer 190 may include a metal. For example, the marking layer 190 may include copper. The marking layer 190 may be formed through copper plating between the first case portion 102 and the second case portion 122. Because the marking layer 190 including a metal according to an embodiment increases process yield, production costs of the memory card 100 may be reduced. In addition, because the marking layer 190 including a metal has a high reflectance, visibility of the product information of the memory card 100 of the inventive concept may be improved.

In some embodiments, the marking layer 190 may be located between the marking area of the second case portion 122 and the first case portion 102. The marking area may be an area including the plurality of through-holes 192 to indicate the product information of the memory card 100. The marking layer 190 may be located on the area including the plurality of through-holes 192. For example, the marking layer 190 may cover upper portions of the plurality of through-holes 192. The marking layer 190 may be exposed to the outside through the plurality of through-holes 192, and an inner surface of the first case portion 102 might not be exposed to the outside. The marking area indicating the product information of the memory card 100 may be covered by the marking layer 190 so that the marking layer 190 exposed to the outside displays the product information.

In some embodiments, the marking layer 190 may be spaced apart from the integrated circuit package 180. The marking layer 190 and the integrated circuit package 180 may be spaced apart from each other in the Y axis direction. The marking layer 190 may be located between the marking area of the second case portion 122 and the first case portion 102, and the integrated circuit package 180 may be located in the inner space of the first and second case portions 102 and 122 where the marking layer 190 is not located.

Because the product information of the memory card 100 is displayed through the plurality of through-holes 192 and the marking layer 190 located in the first and second case portions 102 and 122 are exposed to the outside through the plurality of through-holes 192, visibility of the product information may be improved. Because visibility of product information is improved through the plurality of through-holes 192 and the marking layer 190, a degree of freedom in selecting a material of the first and second case portions 102 and 122 may increase. For example, there is no need to limit a material so that a color of the first and second case portions 102 and 122 is black for visibility of the product information. Accordingly, costs incurred in a process of manufacturing the first and second case portions 102 and 122 may be reduced. In addition, by selecting a material of the first and second case portions 102 and 122, physical deformation such as warpage of the memory card 100 may be suppressed.

Specific shapes of the first case portion 102 and the second case portion 122 in the memory card 100 of some embodiments will now be described. The first case portion 102 may be referred to as an upper case, and the second case portion 122 may be referred to as a lower case.

As shown in FIG. 1, the first case portion 102 may include a first upper case edge 104, and a second upper case edge 108 connected to the first upper case edge 104. In addition, the first case portion 102 may include a third upper case edge 106 connected to the second upper case edge 108, and a fourth upper case edge 110 connected to the third upper case edge 106 and the first upper case edge 104.

The upper case chamfer 116 having an inclined shape may be located at a corner between the first upper case edge 104 and the fourth upper case edge 110. The upper case chamfer 116 having a cut corner portion may be located between the first upper case edge 104 and the fourth upper case edge 110. The upper case chamfer 116 may be connected to the first upper case edge 104 and the fourth upper case edge 110.

As shown in FIG. 2, the second case portion 122 may include a first lower case edge 124, and a second lower case edge 130 connected to the first lower case edge 124. In addition, the second case portion 122 may include a third lower case edge 126 connected to the second lower case edge 130, and a fourth lower case edge 128 connected to the third lower case edge 126 and the first lower case edge 124.

The lower case chamfer 132 having an inclined shape may be located at a corner between the first lower case edge 124 and the fourth lower case edge 128. The lower case chamfer 132 having a cut corner portion may be located between the first lower case edge 124 and the fourth low case edge 128. The lower case chamfer 132 may be connected to the first lower case edge 124 and the fourth lower case edge 128.

When the first case portion 102 and the second case portion 122 are coupled to each other, the first upper case edge 104 and the first lower case edge 124 may contact each other, the second upper case edge 108 and the second lower case edge 130 may contact each other, the third upper case edge 106 and the third lower case edge 126 may contact each other, and the fourth upper case edge 110 and the fourth lower case edge 128 may contact each other.

The first upper case edge 104, the second upper case edge 108, the third upper case edge 106, and the fourth upper case edge 110 may be respectively aligned with and coupled to the first lower case edge 124, the second lower case edge 130, the third lower case edge 126, and the fourth lower case edge 128. The upper case chamfer 116 may be aligned with and coupled to the lower case chamfer 132.

The first upper case edge 104 and the first lower case edge 124 may be referred to as first case portion edges 104 and 124. The second upper case edge 108 and the second lower case edge 130 may be referred to as second case portion edges 108 and 130. The third upper case edge 106 and the third lower case edge 126 may be referred to as third case edges 106 and 126. The fourth upper case edge 110 and the fourth lower case edge 128 may be referred to as fourth case edges 110 and 128. The upper case chamfer 116 and the lower case chamfer 132 may be referred to as case chamfers 116 and 162.

The first and second case portions 102 and 122 may include the first case portion edges 104 and 124, the second case portion edges 108 and 130 connected to the first case portion edges 104 and 124, the third case edges 106 and 126 connected to the second case portion edges 108 and 130, and the fourth case edges 110 and 128 connected to the third case edges 106 and 126 and the first case portion edges 104 and 124. The case chamfers 116 and 132 having inclined shapes and connected to the first case portion edges 104 and 124 and the fourth case edges 110 and 128 may be located.

In some embodiments, the first and second case portions 102 and 122 may include a first recess groove 112. The first recess groove 112 may be located at the second case portion edges 108 and 130 adjacent to the first case portion edges 104 and 124. The first recess groove 112 may be located at the second case portion edges 108 and 130 to be spaced apart from the first case portion edges 104 and 124. The first recess groove 112 may be a groove that is recessed inward.

In some embodiments, a switch 118 may be located in the first recess groove 112. The switch 118 may vertically move in the first recess groove 112. The switch 118 may be a member for turning on or off a write function of the integrated circuit package 180 of the memory card 100.

In some embodiments, the first and second case portions 102 and 122 may include a second recess groove 114. The second recess groove 114 may be located at the fourth case edges 110 and 128 adjacent to the first case portion edges 104 and 124. The second recess groove 114 may be located at the fourth case edges 110 and 128 to be spaced apart from the first case portion edges 104 and 124. The second recess groove 114 may be a groove that is recessed inward. The second recess groove 114 may be a groove member used when the memory card 100 is inserted into an external device.

In the memory card 100 of some embodiments, specific positions of the integrated circuit package 180 and the marking layer 190 in the inner space of the first and second case portions 102 and 122 will now be described.

In some embodiments, the external contact terminals 136 may be located adjacent to the first case portion edges 104 and 124 of the first and second case portions 102 and 122. The integrated circuit package 180 including the external contact terminals 136 may be located adjacent to the first case portion edges 104 and 124. The integrated circuit package 180 may include, on a side, a chamfer having an inclined shape corresponding to the case chamfers 116 and 132.

In some embodiments, the marking layer 190 may be located adjacent to the third case edges 106 and 126 of the first and second case portions 102 and 122. The marking layer 190 may be spaced apart from the external contact terminals 136. The marking area of the second case portion 122 may be located adjacent to the third case edges 106 and 136, and the marking layer 190 may be located to cover the plurality of through-holes 192 of the marking area.

In some embodiments, the marking layer 190 may be spaced apart from the first case portion edges 104 and 124 with the integrated circuit package 180 therebetween. The marking layer 190 and the integrated circuit package 180 may be located at the same vertical level in the Z axis direction, and the marking layer 190 may be spaced apart from the first case portion edges 104 and 124 with the integrated circuit package 180 therebetween. The marking layer 190 might not include a chamfer corresponding to the case chamfers 116 and 132.

In some embodiments, the marking layer 190 may be located between the first recess groove 112 and the third case edges 106 and 126. The marking layer 190 may be located at a lower position than the first recess groove 112 in the Y axis direction. The marking layer 190 may be located at a lower position than a horizontal axis parallel to the X axis crossing the first recess groove 112 in the Y axis direction.

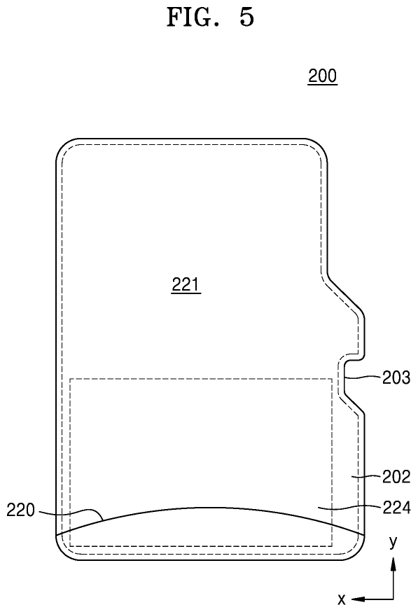

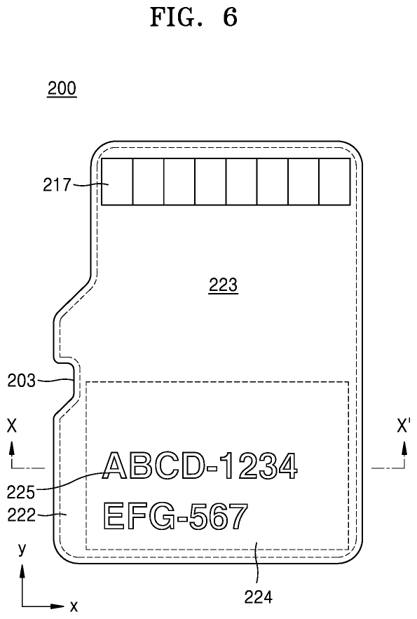

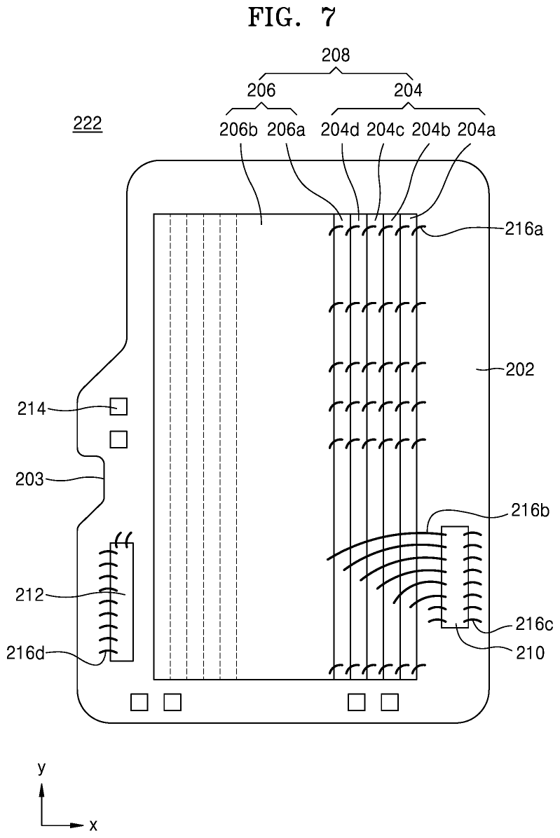

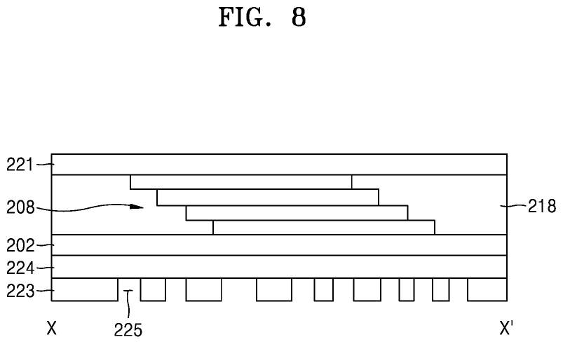

FIG. 5 is a plan view schematically illustrating a memory card, according to an embodiment. FIG. 6 is a bottom view schematically illustrating a memory card, according to an embodiment. FIG. 7 is a plan view schematically illustrating an integrated circuit package of the memory card of FIG. 5. FIG. 8 is a cross-sectional view illustrating the memory card of FIG. 6, taken along line X-X′.

Referring to FIGS. 5 to 8, a memory card 200 may include upper and lower cases 221 and 223, an integrated circuit package 222, and a marking layer 224. Although the memory card 200 is similar to a micro SD card in FIGS. 5 to 8, this is merely an example, and the technical spirit and scope of the inventive concept may be applied to any of various memory cards such as a mini SD card.

The upper and lower cases 221 and 223 of the memory card 200 may include the upper case 221 and the lower case 223. The upper case 221 may be the first case portion 102 of FIG. 1. The lower case 223 may be the second case portion 122 of FIG. 2.

The upper case 221 and the lower case 223 may be coupled to each other. The upper case 221 and the lower case 223 may be coupled to each other to have an inner space. The upper case 221 and the lower case 223 may be coupled to each other to include the integrated circuit package 222 and the marking layer 224 therein.

The upper and lower cases 221 and 223 may be referred to as housings. The upper and lower cases 221 and 223 may be referred to as outer lids. When the memory card 100 is an SD card or a mini SD card, sizes of the upper case 221 and the lower case 223 may be determined according to standard specifications.

The lower case 223 may include a plurality of through-holes 225. The lower case 223 may include a hole penetrating from a top surface to a bottom surface. The lower case 223 may include the plurality of through-holes 225 through which the inner space of the upper and lower cases 221 and 223 is exposed to the outside.

The plurality of through-holes 225 of the lower case 223 may be formed to display product information of the memory card 200 in characters. When the memory card 100 is viewed from a bottom surface, the plurality of through-holes 225 may appear as characters conveying the product information.

In some embodiments, the lower case 223 may include a marking area. The marking area may be an area indicating the product information of the memory card 200. The plurality of through-holes 225 may be located in the marking area.

In some embodiments, the upper case 221 may include a protrusion 220. The protrusion 220 may protrude outward from a top surface of the upper case 221. In the upper case 221, a thickness of a portion where the protrusion 220 is located may be greater than a thickness of other portions.

A side wall of the protrusion 220 may be round. In detail, a side wall located on the top surface of the upper case from among side walls of the protrusion 220 may be round. A length of the protrusion 220 in the Y axis direction may vary according to a portion. For example, a length of the protrusion 220 in the Y axis direction may increase away from two facing case edges of the upper case 221 in the X axis direction. In a plan view of the memory card 200, the protrusion 220 may be convex upward.

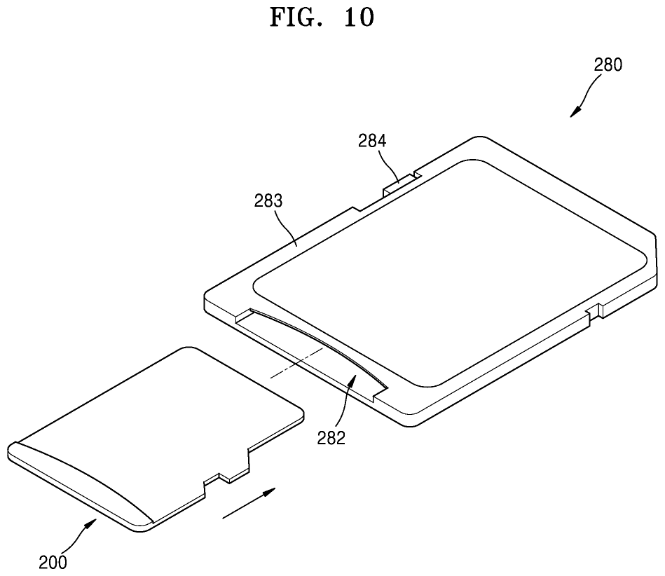

In some embodiments, the upper and lower cases 221 and 223 may include a recess groove 203. The recess groove 203 may be a groove that is recessed inward. The recess groove 203 may be a groove member used when the memory card 200 is inserted into an adapter 208 (see FIG. 10).

In some embodiments, external contact terminals 217 may be formed on a bottom surface of a panel substrate 202 of the integrated circuit package 222. The external contact terminals 217 may be provided for electrical connection between electronic elements mounted on the panel substrate 202 and an external electronic device. The external contact terminals 217 may be a signal terminal, a ground terminal, and power supply terminals. The lower case 223 may include openings through which the external contact terminals 217 are exposed.

The integrated circuit package 222 of the memory card may be located between the upper case 221 and the lower case 223. The integrated circuit package 222 may be located in the inner space of the upper and lower cases 221 and 223.

The integrated circuit package 222 may include a stacked memory chip 208, a controller chip 212, a passive element 214, and a molding layer 218 located on the panel substrate 202. In some embodiments, the integrated circuit package 222 may further include an FBI chip 210.

The panel substrate 202 may correspond to the panel substrate 140 of FIG. 4. The stacked memory chip 208 may correspond to the stacked memory chip 144 of FIG. 4. Memory chips 204 and 206 may correspond to the memory chips (e.g., 141 and 143) of FIG. 4. The controller chip 212, the passive element 214, the molding layer 218, and the FBI chip 210 may respectively correspond to the controller chip 146 (see FIG. 4), the passive element 180 (see FIG. 4), the molding layer, and the FBI chip 142 (see FIG. 4).

The marking layer 224 of the memory card 200 may be located between the upper case 221 and the lower case 223. The marking layer 224 may be exposed to the outside through the plurality of through-holes 225 of the lower case 223. A color of the marking layer 224 may be different from a color of the lower case 223. The marking layer 224 exposed through the plurality of through-holes 225 may have a color different from a color of the lower case 223. Accordingly, in the memory card 200 of the inventive concept, visibility of the product information indicated through the plurality of through-holes 225 may increase.

In some embodiments, the stacked memory chip 208 may be located on a top surface of the panel substrate 202 of the integrated circuit package 222, and the marking layer 224 may be located on a bottom surface of the panel substrate 202. The marking layer 224, the panel substrate 202, and the stacked memory chip 208 may be sequentially stacked. The marking layer 224 may contact the integrated circuit package 222. The marking layer 224 may be formed through copper plating in a process of forming the panel substrate 202. Although the marking layer 224 is formed in a certain portion of the panel substrate 202 in FIG. 7, the inventive concept is not limited thereto, and the marking layer 224 may be formed in any portion of the panel substrate 202.

As shown in FIG. 8, the marking layer 224 and the integrated circuit package 222 may be located between the upper case 221 and the lower case 223. In some embodiments, the lower case 223, the marking layer 224, the panel substrate 202, the stacked memory chip 208, and the upper case 221 may be sequentially stacked. A bottom surface of the marking layer 224 may be exposed to the outside through the plurality of through-holes 225 of the lower case 223. In this case, the integrated circuit package 222 may be covered by the marking layer 224 and might not be exposed to the outside.

Because the product information of the memory card 200 is displayed through the plurality of through-holes 225, and the marking layer 224 located between the upper and lower cases 221 and 223 is exposed through the plurality of through-holes 225, visibility of the product information may be improved. Because visibility of the product information is improved through the plurality of through-holes 225 and the marking layer 224, a degree of freedom in selecting a material of the upper and lower cases 221 and 223 may increase. For example, there is no need to limit a material so that a color of the upper and lower cases 221 and 223 is black for visibility of the product information. Accordingly, costs incurred in a process of manufacturing the upper and lower cases 221 and 223 may be reduced. In addition, by selecting a material of the upper and lower cases 221 and 223, physical deformation such as warpage of the memory card 200 may be suppressed.

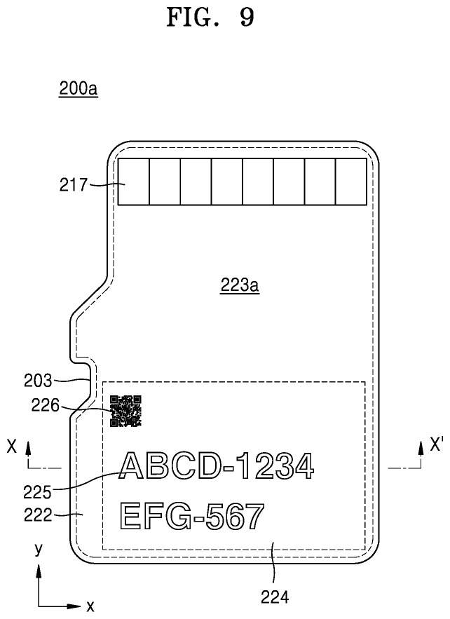

FIG. 9 is a bottom view schematically illustrating a memory card, according to an embodiment.

Referring to FIG. 9, a memory card 200a may include the upper and lower cases 221 and 223, the integrated circuit package 222, and the marking layer 224.

When the memory card 200a of FIG. 9 is described, the same description as that made for the memory card 200 (see FIG. 5) will be omitted and a difference will be mainly described.

The upper and lower cases 221 and 223 may include the upper case 221 and the lower case 223. The lower case 223 may include the plurality of through-holes 225. The plurality of through-holes 225 may be arranged to form a two-dimensional (2D) code 226. When the memory card 200a is viewed from a bottom surface, at least some of the plurality of through-holes 225 may be formed to appear as the 2D code 226. In some embodiments, the 2D code 226 may include a quick response (QR) code. The 2D code 226 may include a larger amount of information than text or a one-dimensional (1D) code.

FIG. 10 is a bottom view schematically illustrating a memory card, according to an embodiment.

Referring to FIG. 10, the memory card may include the upper and lower cases 221 and 223, the integrated circuit package 222, the marking layer 224, and the adapter 280.

When the memory card of FIG. 10 is described, the same description as that made for the memory card 200 of FIG. 5 will be omitted and a difference will be mainly described.

The adapter 280 may include an insertion portion 282 into which the upper and lower cases 221 and 223 may be inserted, an adapter case 283, and an adapter switch 284. The adapter switch 284 may be a member for turning on or off a write function of the integrated circuit package 222. The upper and lower cases 221 and 223 may be inserted into the insertion portion 282 and completely accommodated in the memory card adapter 280.

The upper and lower cases 221 and 223 may be inserted into the adapter 280, and the integrated circuit package 222 may input and output data to and from an external device through the adapter 280. Because an external terminal of the integrated circuit package is connected to a terminal in the adapter, data input/output to/from the external device may be executed.

While the inventive concept has been particularly shown and described with reference to embodiments thereof, it will be understood that various changes in form and details may be made therein without departing from the spirit and scope of the following claims.

What is claimed is:

1. A memory card comprising:
a case comprising a first case portion and a second case portion that is coupled to the first case portion, the case further comprising a recess groove recessed inward on one side;
an integrated circuit package located in the case and comprising a panel substrate and a stacked memory chip;
a marking layer located in the case; and
an adapter comprising an insertion hole into which the case is inserted,
wherein the case comprises a marking area in the second case portion,
wherein the second case portion comprises a plurality of through-holes in the marking area,
wherein the marking area is disposed adjacent to the marking layer such that the through-holes expose a part of the marking layer.

2. The memory card of claim 1, wherein the marking layer comprises a metal,
wherein a color of the marking layer is different from a color of the second case portion, and
the marking layer is exposed to an outside through the plurality of through-holes.

3. A memory card comprising:
a case comprising a first case portion and a second case portion that is coupled to the first case portion;
an integrated circuit package located in the case; and
a marking layer located in the case,
wherein the second case portion comprises a through-hole,
wherein the marking layer is exposed to an outside through the through-hole.

4. The memory card of claim 3, wherein a color of the case and a color of the marking layer are different from each other.

5. The memory card of claim 3, wherein the marking layer comprises a metal.

6. The memory card of claim 3, wherein the case is green.

7. The memory card of claim 3, wherein the integrated circuit package and the marking layer are spaced apart from each other.

8. The memory card of claim 3, wherein the case comprises a first case portion edge, a second case portion edge connected to the first case portion edge, a third case edge connected to the second case portion edge, and a fourth case edge connected to the third case edge and the first case portion edge,
wherein the second case portion edge comprises a first recess groove that is spaced apart from the first case portion edge and is recessed inward.

9. The memory card of claim 8, wherein the fourth case edge comprises a second recess groove that is spaced apart from the first case portion edge and is recessed inward.

10. The memory card of claim 8, wherein the marking layer is located between the first recess groove and the third case edge.

11. The memory card of claim 8, wherein the marking layer is spaced apart from the first case portion edge with the integrated circuit package therebetween.

12. The memory card of claim 8, further comprising a switch located in the first recess groove.

13. The memory card of claim 8, further comprising a case chamfer having an inclined shape and connected to the first case portion edge and the fourth case edge.

14. A memory card comprising:
a first case portion;
a second case portion coupled to the first case portion and comprising a marking area;
an integrated circuit package located between the first case portion and the second case portion; and
a marking layer located between the integrated circuit package and the second case portion,
wherein the second case portion comprises a plurality of through-holes in the marking area.

15. The memory card of claim 14, wherein the marking layer is exposed to an outside through the plurality of through-holes.

16. The memory card of claim 14, wherein at least some of the plurality of through-holes are arranged to form a two-dimensional (2D) code.

17. The memory card of claim 14, wherein the integrated circuit package comprises a panel substrate and a stacked memory chip,
wherein the stacked memory chip is located on a top surface of the panel substrate, and
the marking layer is located on a bottom surface of the panel substrate.

18. The memory card of claim 14, further comprising an adapter into which the first case portion and the second case portion are inserted.

19. The memory card of claim 18, wherein the adapter comprises a switch located on a side of the adapter.

20. The memory card of claim 14, wherein the first case portion comprises a protrusion protruding outward from a top surface.
